(19) United States
(12) Patent Application Publication
(10) Pub. No.: US 2006/0110103 A1
(43) Pub. Date: May 25, 2006

(54) Optoelectronic devices

(76) Inventor: Jeremy C. Rice-McDonald, Perthshire (GB)

Correspondence Address: OLIFF & BERRIDGE, PLC, P.O. BOX 19928, ALEXANDRIA, VA, 22320, US

(21) Appl. No.: 11/251,924

(22) Filed: Oct. 18, 2005

Related U.S. Application Data
(63) Continuation-in-part of application No. 10/257,007, filed on Dec. 13, 2002, now abandoned.

(30) Foreign Application Priority Data
Apr. 14, 2000 (GB) GB0009309.6
Mar. 18, 2005 (GB) GB505583.5
Apr. 13, 2005 (GB) GB507400.0

(51) Int. Cl. G02B 6/42

(52) U.S. Cl. 385/31

(57) ABSTRACT

A locking mechanism suitable for a door or window comprises a barrel having a passage or keyway, a key insertable into the passage or keyway, one or more light sources for generating and transmitting an optical signal and one or more receivers for receiving the or each optical signal. A number of optically conductive units are arranged substantially regularly within the key for optically coupling the light sources and the receivers so as to operate the locking mechanism. An apparatus for conducting an optical signal suitable for use in the key comprises a plurality of optically conductive blocks, each block cooperating with another to define a pathway for the optical signal in at least two dimensions.

This application is a continuation-in-part application of U.S. patent application Ser. No. 10/257,007, filed Dec. 13, 2002, which is a National Stage of Application No. PCT/GB01/01706 filed Apr. 12, 2001, the entire contents of all of which are herein incorporated by reference.

The present invention is concerned with improvements in or relating to optoelectronic devices. The invention particularly, but not exclusively, relates to a method and/or apparatus for conducting an optical signal and to an optoelectronic locking system or apparatus within which such a method and/or apparatus may be usefully employed.

It is becoming increasingly common in electronics applications, including security devices such as locking systems, to replace electrical connections between components with optical connections. The greatly increased speed at which optical signals can be transmitted means that they can support much higher data and switching rates than conventional electrical signals. Furthermore, optical signals do not generate electrical or electromagnetic noise which can distort electrical conductors through cross-talk or other interference. Nor are they susceptible to such noise generated by nearby electrical conductors.

For this reason, optical and optoelectronic lock and key systems have recently been proposed. For example, FR2,453,559 discloses an optoelectronic lock and key arrangement comprising a lock having a single light source and a plurality of optical detectors, each optically coupled to a lock barrel via optical fibres. A key containing a plurality of optical fibres is insertable into the barrel so as to optically connect the light source to the optical detectors, thereby to activate the lock. GB2,000,544 discloses a lock having one or more light sources opening into its barrel and one or more detectors which are spaced apart lengthwise along the barrel and angularly offset. The associated key has an energy guide within it, the ends of which cooperate with the light source and the detector when the key is fully inserted into the barrel such that the detector is energised to produce a control signal.

Nevertheless, there are inherent problems involved in the use of optical signal communication and this has thus far limited the spread of this technology. One such problem lies in the control and/or directivity of the optical signals. Unlike the use of electrical signals where an air gap may be used as an electrical insulator, air is a good optical conductor and so means must be provided for controlling the light signals. Furthermore, optical components are relatively costly to assemble due to the difficulty in aligning the components to the very small tolerances required for effective signal transmission and conduction.

The aforementioned prior art optoelectronic lock and key systems employ one or more optical fibres disposed within the key. Optical fibres, sometimes known as “light pipes”, are currently the means most commonly employed for guiding or directing optical signals. Optical fibres usually consist of a cylindrical glass core which is surrounded by an outer sheath or cladding having a lower refractive index than that of the core. Light propagation through the fibre is achieved through the principle of total internal reflection (TIR). Here, a beam of light is continually reflected back into the core by the cladding so as to be propagated along the length of the fibre.

Optical fibres, often having an overall diameter in the region of around 100-150 microns, usually exhibit good mechanical flexibility and are able to be bent or twisted to a certain extent without deterioration of the signal. However, the manner in which light is propagated through the optical fibre means that the radius of curvature in the fibre must be relatively high. The formation of tight bends within a fibre can cause deterioration of the signal and so the amount of directional change which can be achieved by an optical fibre is restricted by the size of the packaging within which the fibre is to be located. This may represent a particular difficulty where a number of optical fibres is required to be located within a relatively small device such as a key.

The difficulties in packaging optical fibres coupled with the current trend towards size reduction thus hamper their widespread use in electronic devices and, in the case of the prior art lock and key devices mentioned above, limit the number of optical fibres that can be contained in the key without significant signal losses. As a result, the number of “combinations” provided by the devices is limited.

It is therefore an aim of the invention to provide a method and/or apparatus which more easily permits the use of optical signals for signal communication within an electronic device. It is desirable that such a method and/or apparatus exhibit low cost, ease of manufacture and assembly and ease of connectivity to other optical components within the device.

It is a further aim of the invention to provide an improved optoelectronic locking system which addresses the above-mentioned problems associated with the prior art. Other aims and/or objects of the invention will become apparent from the following description.

According to one aspect of the present invention, therefore, there is provided an apparatus for conducting an optical signal comprising a plurality of optically conductive blocks, each block cooperating with another to define a pathway for the optical signal in at least two dimensions.

In one embodiment, each block is regular in shape having at least one face or surface which cooperates with that of another block. In one embodiment, at least one of the blocks comprises a cube having six faces. In one embodiment, at least one of the blocks is substantially rectangular in shape. In one embodiment, each of the blocks is substantially identical in size and/or shape.

The blocks may be arranged in a two- or three-dimensional matrix thereby to form the apparatus.

In one embodiment, at least one of the blocks (which may be referred to as a “thru” block) has two substantially opposing, optically conductive faces (which may be referred to as “active” faces) thereby to define a substantially straight pathway for an optical signal therebetween. The remaining face or faces of the block (which may be referred to as “inactive” faces) may optionally be suitably coated or clad to reduce or substantially eliminate transmission of the optical signal therethrough.

For example, the or each inactive face may be coated in a reflective material, a substantially opaque material or a material having a lower refractive index than the body proper of the block, the latter thereby facilitating substantially total internal reflection within the block in a manner similar to conventional optical fibres.

In one embodiment, at least one of the blocks (which may be referred to as a “corner” block) includes a reflective member for changing the direction of transmission of an optical signal incident thereon. The reflective member may comprise a mirror or other reflective surface which may be disposed within the body of the block and inclined relative to one of the faces thereof. In one embodiment, a mirror is disposed within the block at an angle of approximately 45° relative to the active faces thereof, which active faces are mutually perpendicular.

In one embodiment, the reflective member may be reflective on two opposing sides thereof. In this embodiment, the corner block may include four active faces for the conduction of two optically isolated signals therethrough, each optical signal being turned through approximately 90°.

Thus, in a thru block, there may be two active faces which are plane parallel. In a corner block, there may be two active faces which are orthogonal. In one embodiment, at least one of the blocks (which may be referred to as a “dead” block) is substantially optically non-conductive, and may be employed to terminate one or more optical pathways within the apparatus or to optically isolate optical signals within the apparatus.

The or each thru and corner blocks may be formed from any suitable material including: polyurea, urea formaldehyde, polymethylacrylate, polystyrene, CD grade polycarbonate, conventional or optical grade glass, all of which may have appropriate mechanical and/or optical properties. The or each dead block may be formed from a substantially opaque material.

According to another aspect of the invention there is provided a locking mechanism for a door, window or the like comprising a lock barrel and a key adapted for insertion into the barrel, at least one of the lock barrel and the key including an apparatus as described in the preceding paragraphs.

According to a further aspect of the present invention there is provided a locking mechanism for a door, window or the like, the mechanism comprising a barrel having a passage or keyway disposed therein, a key arranged for insertion into the passage or keyway, one or more light sources for generating and transmitting an optical signal and one or more receivers for receiving the or each optical signal, wherein the key includes a plurality of optically conductive units arranged substantially regularly therein for optically coupling the light sources and the receivers thereby to operate the locking mechanism.

In one embodiment, the optically conductive units comprise one or more photonic crystals or similar disposed within the key. In one embodiment, the optically conductive units comprise an arrangement of blocks of the type described in the preceding paragraphs.

In one embodiment, the or each light source is mounted in or on the barrel for optical communication signal with a passage or keyway defined therein. In one embodiment, the or each receiver is similarly mounted in or on the barrel for optical communication with the passage or keyway.

In one embodiment the locking mechanism comprises one or more optical conductors for conducting the or each optical signal between the or each light source and the barrel. In one embodiment the locking mechanism comprises one or more optical conductors for conducting the or each optical signal between the barrel and the or each receiver. Where present, the or each optical conductor may comprise a light pipe, optical fibre or similar.

In one embodiment, the or each optical signal comprises a visible wavelength electromagnetic signal. For clarity, the term “optical signal” is used to describe an electromagnetic signal having a wavelength of between approximately 1 nm and 1 mm (10⁻⁹ m-10⁻³m) and is not intended to be limited to signals at visible wavelengths. The or each optical signal may therefore comprise a signal at infra-red (IR) wavelengths or, where appropriate, a signal at ultraviolet (UV) wavelengths. The or each optical signal may have any desired wavelength within the above mentioned approximate range.

In one embodiment, the locking mechanism includes encoder means for encoding the optical signal before it is transmitted. In one embodiment, the receivers include decoder means for decoding the signal after it is received.

In one embodiment, the or each light source comprises an LED, which may be a visible wavelength-transmitting LED, an IR-transmitting LED or a UV-transmitting LED.

In one embodiment, the locking mechanism further comprises a switch, the switch being selectively operable to connect the locking mechanism to a power supply. The switch means may be located within the barrel, for example at one end of the passage or keyway and actuable upon the insertion of the key therein thereby to supply power to the locking mechanism.

The various aspects, embodiments and/or alternatives described above may be implemented alone or in any suitable combination.

The present invention will now be described, by way of example only, with reference to the accompanying drawings in which:

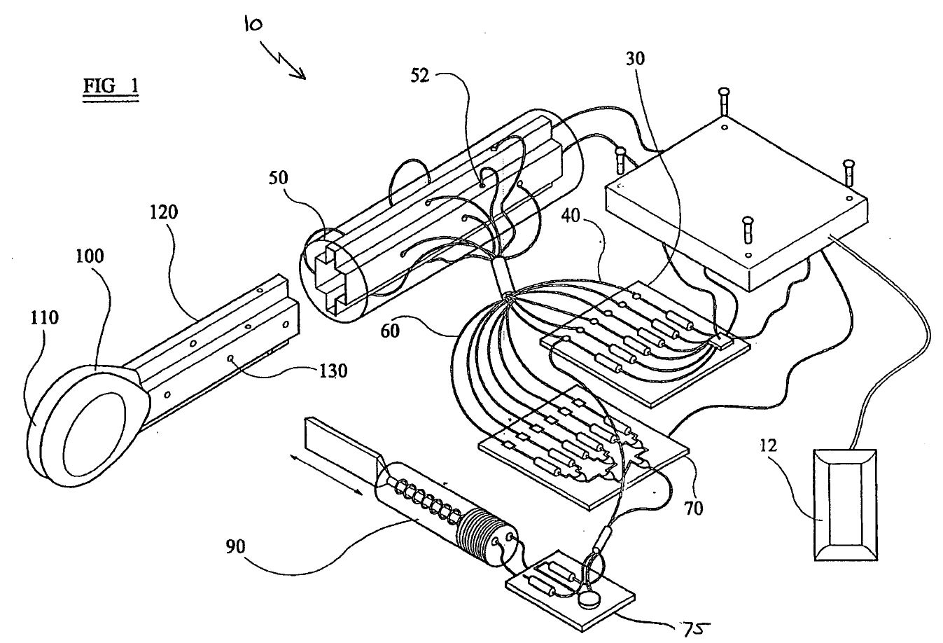

FIG. 1 illustrates a locking mechanism embodying a first form of the invention;

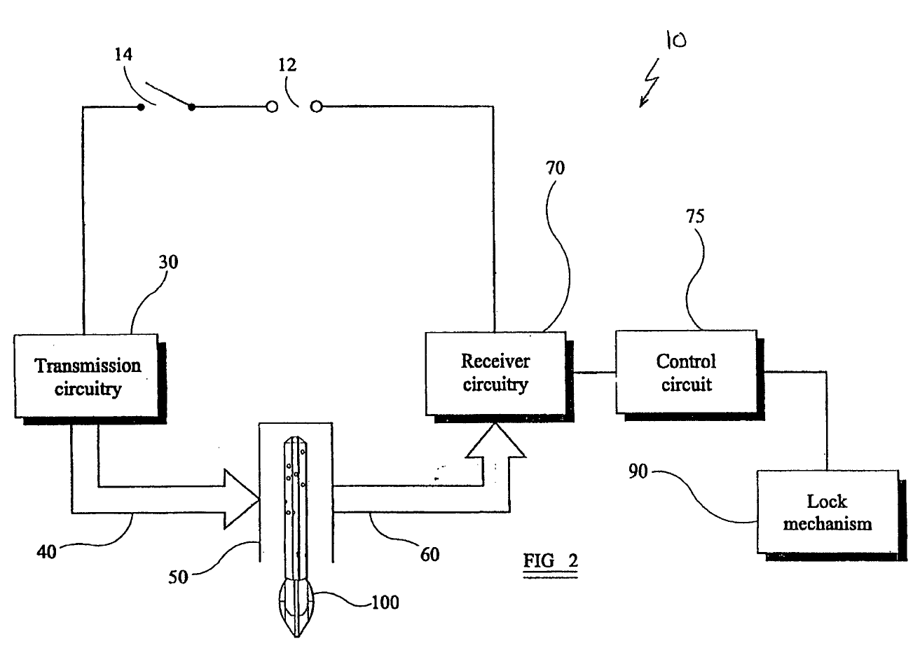

FIG. 2 is a schematic block diagram of the locking mechanism of FIG. 1;

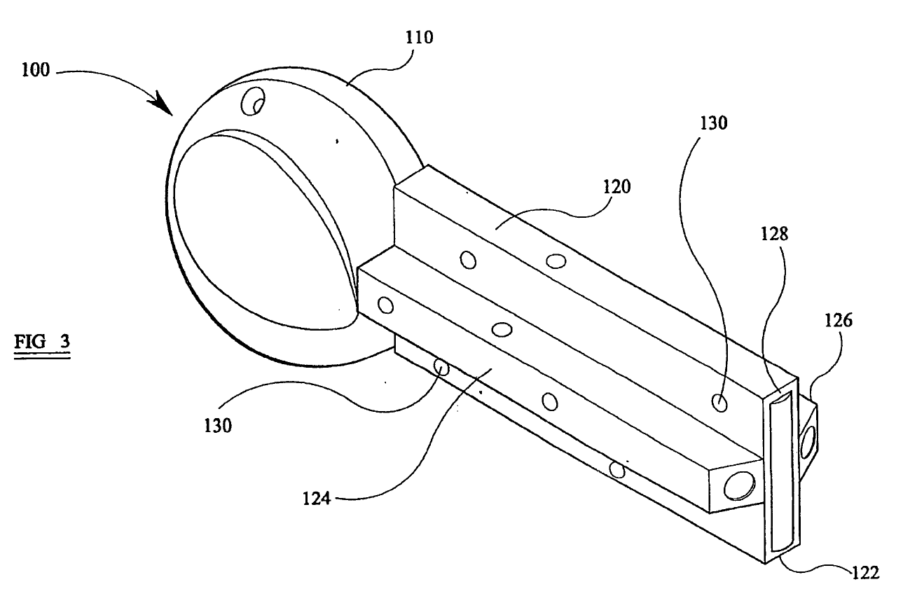

FIG. 3 is a perspective view of an exemplary key for use with the locking mechanism of FIG. 1;

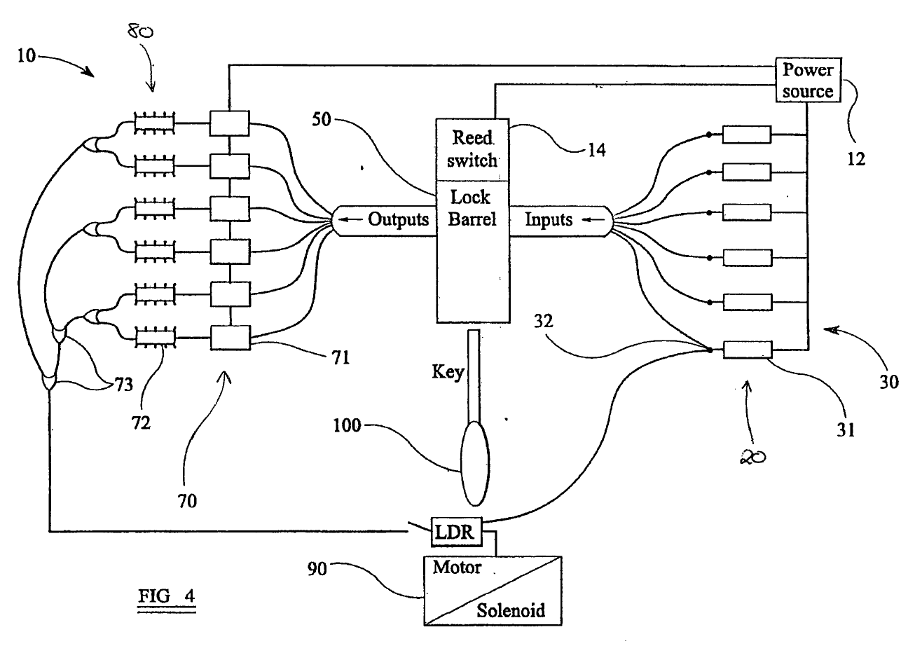

FIG. 4 shows an alternative form of locking mechanism according to the invention;

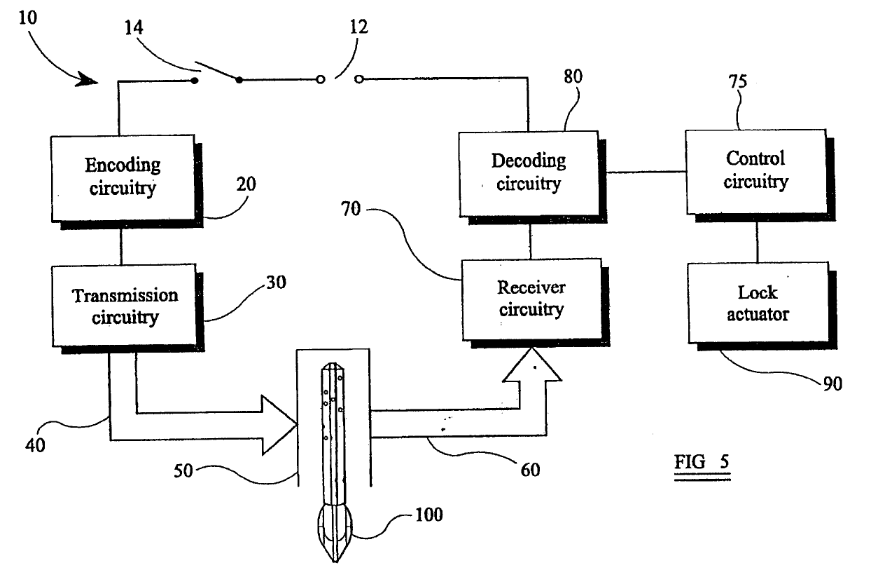

FIG. 5 is a schematic block diagram of the locking mechanism of FIG. 4;

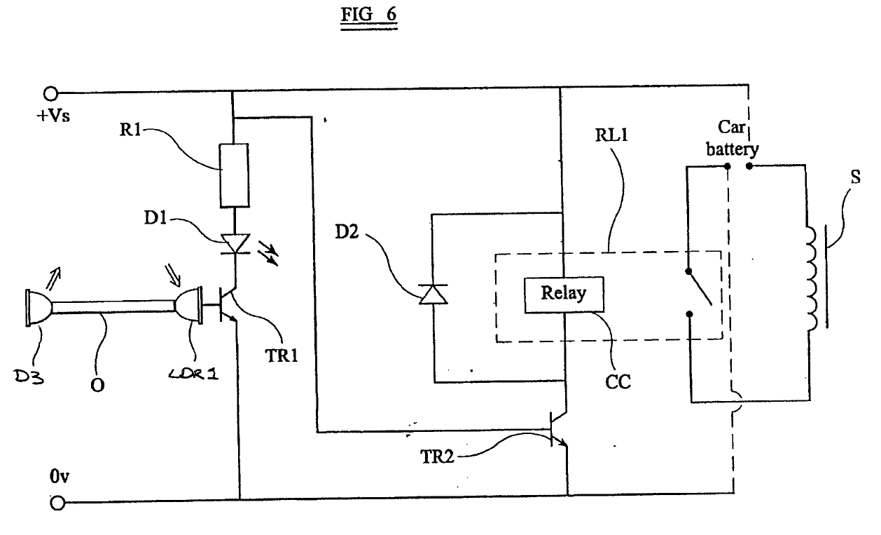

FIG. 6 shows an anti-tampering circuit for use with the locking mechanism of FIG. 1.

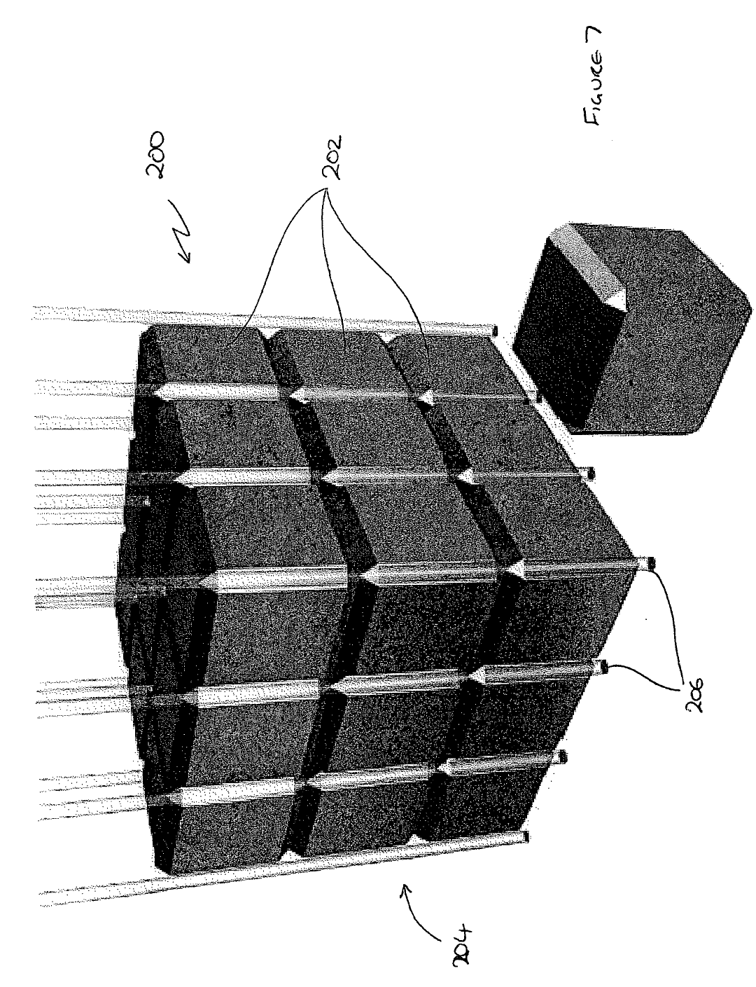

FIG. 7 illustrates an apparatus embodying another form of the invention suitable for use with the mechanism of FIG. 1;

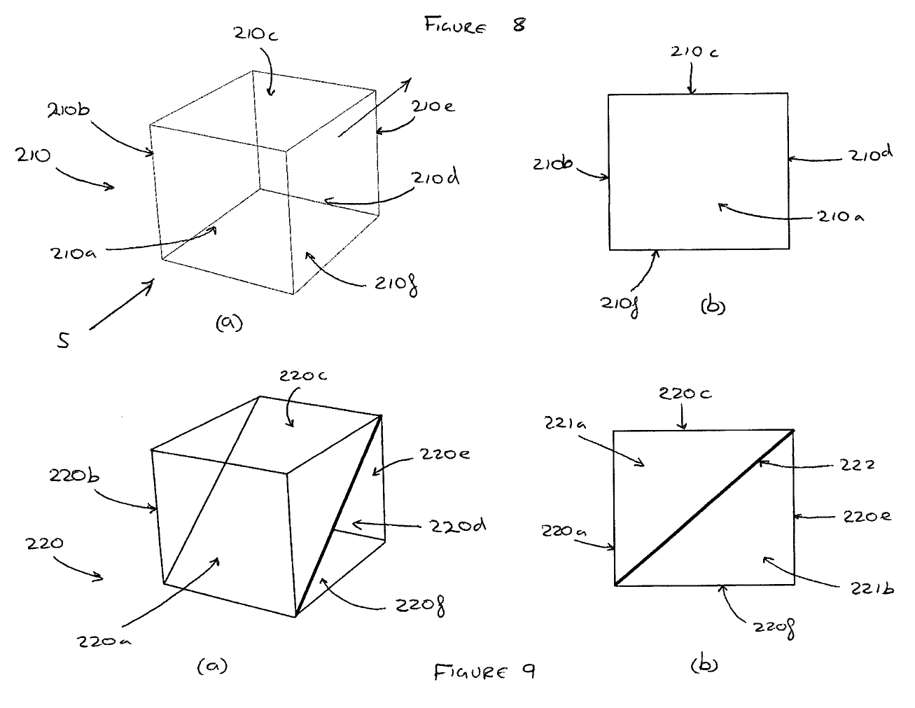

FIGS. 8a and 8b illustrate a first type of block which may be employed by the apparatus of FIG. 7;

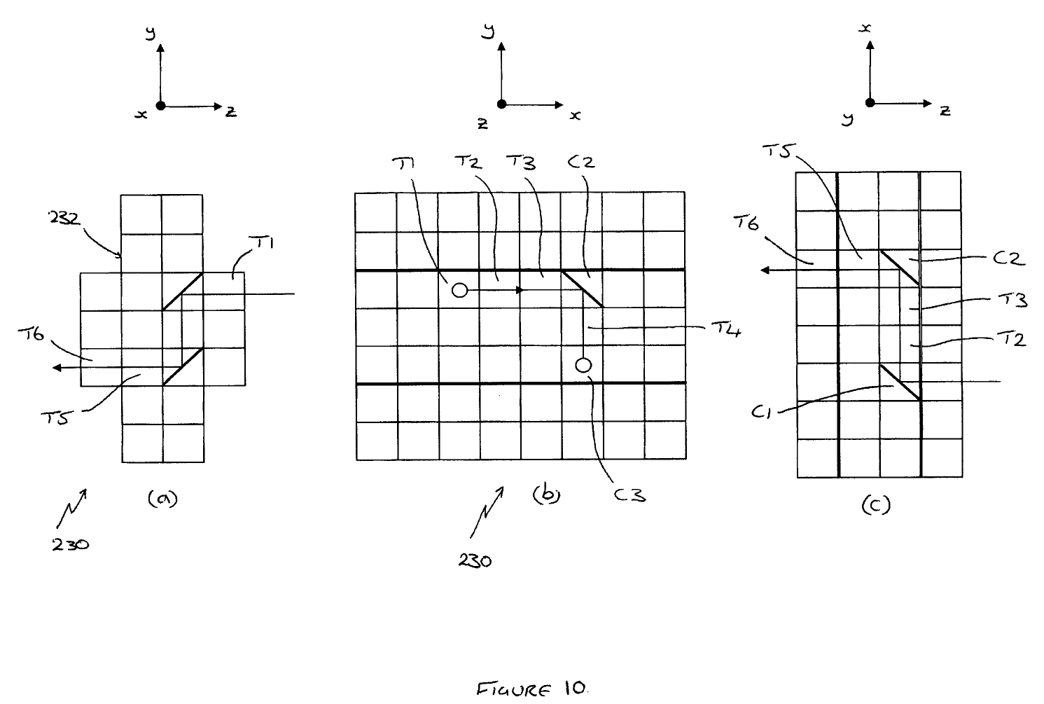

FIGS. 9a and 9b illustrate a second type of block which may be employed by the apparatus of FIG. 7; and

FIGS. 10a-10c illustrate a key embodying one form of the invention for use with the system of FIG. 1.

Referring to FIGS. 1 to 3, a preferred form of locking mechanism is shown generally at 10. In this embodiment, the locking mechanism is suitable for locking and unlocking the doors of vehicles such as cars, vans or the like. It will be appreciated, however, that this is merely an example of one possible application for the locking mechanism.

The locking mechanism 10 comprises a power supply 12 which, in this case, is a 12 volt supply provided by the vehicle battery in a manner similar to that used in conventional vehicle central locking systems.

The locking mechanism 10 has a barrel 50 which, in this embodiment, is generally cylindrical in external shape so as to fit into apertures provided in the vehicle door. Associated with the barrel 50 is a key 100, a form of which is shown in FIG. 3, comprising a handle portion 110 and a substantially hollow shank portion 120. In the illustrated embodiment, the shank portion 120 comprises four parallel, conjoined arms 122, 124, 126, 128 which are arranged such that the cross-section of the shank portion 120 is substantially cross shaped along its length.

Disposed along the parallel faces of the arms are a plurality of apertures 130. Each of the apertures 130 is internally connected to another aperture by means of a substantially regular arrangement of optically conductive units housed within the shank and defining one or more optical pathways between the respective apertures 130.

The internal cross section of the barrel 50 is shaped to correspond to the cross section of the shank 120 of the key 100. Thus, the barrel 50 includes a passage or keyway consisting of four channels running parallel to each other along the length of the barrel, each channel being designed to receive one of the arms of the key 100. A plurality of apertures 52 are disposed along the faces of the channels in the barrel and correspond in number and position to the apertures 130 disposed on the shank of the key.

Each of the apertures 52 in the barrel 50 is connected either to a transmission circuit 30 or to a receiver circuit 70 by means of a respective optical link 40, 60 comprising a plurality of optical fibres. The transmission circuit 30 includes a plurality of light sources, such as LED's or the like, and is operable to activate the light sources to generate a plurality of light signals, each of which is transmitted along the optical fibre link 40 to one of the apertures 130 in the barrel 50.

The receiver circuit 70 includes a plurality of sensors or detectors which are operable to detect light signals such as photodiodes, LDRs or the like. The sensors are arranged to receive light signals transmitted along the optical fibre link 60 from the apertures 52 in the barrel 50.

The receiver circuit 70 is connected to a control circuit 75 which is additionally connected to the lock actuator 90 of the vehicle door.

The locking mechanism 10 further includes a switch 14, for example a reed switch, which is selectively operable to connect the locking mechanism 10 to the power supply 12. Although, in FIG. 2, the switch 14 is shown separate from the barrel 50, the switch 14 may be usefully located within the barrel 50 itself as shown in FIG. 4 and is arranged such that the switch is closed only when the key 100 is fully inserted in the barrel 50. In this regard, the shank 120 of the key 100 may be made of a conducting material so that insertion of the key in the barrel makes a contact between two electrodes of the switch 14 thereby completing a circuit and providing electrical power to the locking mechanism 10.

Operation of the locking mechanism 10 of FIGS. 1-3 is now described. Firstly, a user inserts the key 100 fully into the keyway of the barrel 50. Upon full insertion of the key 100, the end of the shank 120 distal to the handle portion 110 makes contact with the switch 14, actuating same and completing the electrical circuit thereby allowing electrical current to flow from the battery 12 to the transmission circuitry 30 and the receiver circuitry 70.

The transmission circuitry 30 generates light signals from the LED's which are transmitted along the optical fibres 40 to the apertures 52 in the barrel 50. If the correct key is inserted in the barrel, the apertures 130 in the shank 120 of the key 100 and those 52 in the barrel 50 are exactly aligned such that a continuous optical transmission path is provided from the transmission circuitry 30 to the receiver circuitry 70.

The light signals are thus transmitted from the transmission circuitry 30, through the optical fibre link 40, the optical arrangement in the shank 120 of the key 100 and then along the optic fibre link 60 to the receiver circuitry 70. When the sensors in the receiver circuitry 70 receive the light signals generated by the transmission circuitry 30, the receiver circuitry 70 sends a control signal to the control circuitry 75 which actuates the lock actuator 90 thereby to lock or unlock the vehicle door.

It will be appreciated that only a key 100 having apertures 130 which align substantially with the apertures 52 in the barrel 50 can be used to actuate the lock mechanism. Thus, the locking mechanism of the present invention provides a unique “combination” wherein only one key having a specific arrangement of apertures 130 is correctly able to “fit” the lock. The lack of mechanical and moving parts, and the use of optical signals within the key 100 means that the locking mechanism of the present invention is more difficult to circumvent than existing systems.

Various modifications and improvements may be made to the invention. For example, as shown in FIGS. 4 and 5, the locking mechanism may optionally include encoding circuitry 20 and decoding circuitry 80. The encoding circuitry 20 comprises a plurality of pulse generators or the like 31 which generate a coded series of pulses and apply the pulses to the LED's 32 in the transmission circuitry 30. The light signals generated by the LED's 32 are thus encoded into a series of pulses which are transmitted along the optical fibre link 40.

The sensors 71 of the receiver circuitry 70 detect the light signal pulses and convert them into electrical signals which are sent to the decoding circuitry 80. The decoding circuitry comprises a number of microchips 72 which check that the coded signals are correct via logic gates 73.

If all of the signal codes are correct, the decoding circuitry sends a signal to the control circuitry 75 which actuates the lock actuator 90 thereby to lock or unlock the vehicle door.

If desired, the light sources and the detectors may be disposed in or on the barrel 50 itself, for example within the apertures or windows 52, so as to open into the passage or keyway. In this embodiment (not shown), the optical fibres links 40, 60 are not required.

A particular advantage provided by the present invention is that the number of possible combinations provided by the locking mechanism for a given number of LED's/sensors is considerably larger than that provided by prior art locking mechanisms. This is achieved by permitting the possibility that any LED 32 in the transmission circuitry 30 may be connected to any sensor 71 in the receiver circuitry 70. A further increase in the number of combinations can be achieved by varying the position of the apertures 130 on the key and the corresponding apertures 52 in the barrel 50 whilst encoding the light signals transmitted by the LED's 32 permits even greater security.

Advantageously, a helical groove or channel, for example in the form of a Whitworth screw thread, could be machined around the barrel to facilitate the entry and exit of the optical fibres.

In addition, the connecting cable between the control circuitry 75 and the lock actuator 90 may include an optic fibre along which a continuous light signal is transmitted. The lock actuator may be modified such that it will only operate if it is receiving the continuous light signal. If the cable is cut in an attempt to bypass the lock mechanism and power the lock actuator directly from the battery, the light connection will be broken and the lock actuator will not operate.

FIG. 6 shows a preferred form of circuit to achieve this.

In FIG. 6, a positive supply V_{S}, for example from the positive terminal of the vehicle battery, is connected to one electrode of a resistor R1. The other electrode of resistor R1 is connected to the anode of an LED D1, the cathode of which is connected to the collector of a transistor TR1. The emitter of transistor TR1 is connected to the zero volt line of the power supply, for example the earth terminal of the vehicle battery.

The positive supply V_{S}, is connected to the collector electrode of a second transistor TR2 via the coil CC of a relay RL1. The emitter electrode of transistor TR2 is connected to the zero volt line. The relay RL1 is arranged such that when current passes through the coil CC, the relay contacts operate to close a circuit containing a solenoid S for operating the vehicle door locks, thereby to lock the vehicle doors. A diode D2 is reverse biased across the coil CC of the relay to protect the transistor TR2 from any back EMF generated by the relay coil.

The base electrode of transistor TR2 is connected to the first electrode of resistor R1 whilst the base electrode of transistor TR1 is connected to the output of a photosensor, such as a light dependent resistor LDR1. LDR1 is arranged to receive a continuous light signal from light emitting diode D3 via an optic fibre O.

While the photosensor LDR1 is receiving the light signal from the D3 via the optic fibre O, its output is at a high level and transistor TR1 is switched on. Current is therefore conducted through R1, D1 and TR1 and D1 is lit to indicate correct operation. However, if the optic fibre O is cut in an attempt to bypass the lock mechanism, the output of LDR1 switches to a low level and the transistor TR1 will turn off. Current then no longer flows through R1 and D1 and thus the input to the base of transistor TR2 switches to a high level, turning transistor TR2 on. When transistor TR2 switches on, the relay RL1 is energised, the contacts of the relay close and the solenoid S is switched on, thereby activating the vehicle door locks.

A further tamper proof measure involves the inclusion of a time delay circuit to prevent a would-be thief from making numerous attempts at unlocking the vehicle. If an incorrect key is inserted in the barrel, the time delay circuit prevents a further attempt at unlocking the vehicle for a predetermined period of time thereafter. This period of time can be increased following each failed attempt at unlocking the vehicle.

Since the lock mechanism requires only a small amount of electrical power to operate, it can be powered from any convenient source, for example a telephone line, a car battery, stepped down mains power or even a small dynamo in the hinges of the door itself.

Although the embodiment describes the use of visible light for the optical signal, this is not intended to be limiting and electromagnetic signals of different wavelengths may be used such as IR signals, UV signals or the like.

It is envisaged that the regular arrangement of optically conductive units disposed within the key for optically coupling selective and respective apertures 130 in the key 100 may comprise an arrangement of photonic crystals. A photonic crystals is a material which is adaptable to control or manipulate the passage of light therethrough so as to define one or more optical pathways. The properties, uses and methods of application of photonic crystals is well documented and will therefore be understood by the skilled artisan.

An alternative form of optical arrangement suitable for use within the key 100, in addition to many other applications, is described below.

Referring next to FIG. 7, an exemplary apparatus embodying one form of the invention is shown generally at 200. The apparatus 200 is suitable for conducting one or more optical signals, such as visible, IR or UV light signals in one, two or three dimensions and is therefore suitable for use in the key 100 of the locking mechanism 10 described above.

The apparatus 200 comprises a plurality of discrete, multi-sided, optically transmissive bodies or units 202 arranged in a three-dimensional matrix 204. In the illustrated embodiment, each body 202 takes the form of a block or cube having six generally planar sides or faces of substantially equal dimensions.

The matrix 204 consists of a regular arrangement of blocks 202, each of which is positioned with at least one face thereof adjacent to or in abutment with a corresponding face of another block. In the illustrated embodiment, the matrix 204 consists of twenty seven blocks 202 arranged in a 3×3×3 lattice structure. The blocks 202 are held together by support means in the form of a plurality of pins 206 which locate between the blocks and define a cage arrangement. Being modular, i.e. formed from a plurality of discrete bodies, the apparatus 100 may include any desired number of blocks 202 arranged in any desired shape or configuration in dependence upon the purpose for which the apparatus 200 is intended. For example, when used in the key 100 of the locking mechanism 10 described above, the matrix 204 of blocks 202 may be elongate and cross-shaped in section so as to conform to the shape of the shank 120.

Each block 202 is optically conductive, being either fully or partially transparent. In the exemplary embodiment illustrated, each block 202 is formed from a translucent or transparent plastics-based material.

Generally speaking and ignoring any losses due to attenuation, diffraction or refraction, an optical signal that is transmitted into an outer one of the blocks 202 will be conducted through the matrix 204 in a substantially straight line as though the matrix were formed from a single block. However, it is desirable to have the ability to guide or direct the optical signals in more than one dimension so that the matrix 204 can be employed to carry multiple signals which can enter and exit the matrix at a plurality of different positions as desired.

In the illustrated embodiment, this is achieved through the use of different types of blocks 202, each type of block having unique opto-mechanical properties. Examples of such different types of blocks are illustrated in FIGS. 8 and 9.

Referring firstly to FIG. 8a, this is a perspective view of a first type of block 210. Referred to generally as a “thru” block, the block 210 comprises a regular, transparent or translucent cube having six faces 210a-210f of substantially equal surface area. The refractive index of the cube 210 is substantially uniform throughout such that an optical signal S directed into one face, for example face 210a, of the cube is conducted through the material without significant deviation and exits from the opposite side of the block, through face 210e in this example, at approximately the same angle of incidence. It will be understood, therefore, that the thru block 210 functions in a manner similar to an air gap.

In the illustrated embodiment, the faces 210a, 210e through which the optical signal S enters and exits the block are termed “active” faces. The remaining faces, 210b, c, d, f are referred to as “inactive” faces since the optical signal S does not, in normal use, pass therethrough. FIG. 8b illustrates this block in front elevation.

FIG. 9a is a perspective view of a second type of block 220. This block is referred to as a “corner” block and is similar or substantially identical in size and shape to the thru block described above. Thus, the block 220 is cuboid in shape, formed from a generally transparent material and has six substantially equal faces 220a-220f.

In this case, however, the block 220 is adapted to change the direction of optical signals transmitted into the block by up to 90°. Thus, unlike the thru block 210 wherein the active faces 210a, 210e are plane parallel, the active faces 220a, 220c of the corner block 220 are mutually orthogonal.

To change the direction of the optical signal, the block 220 includes a beam directing element in the form of a reflective member 222 which is disposed within the block 220 and is oriented at an angle of approximately 45° to the active faces 220a, 220c of the block.

As best shown in FIG. 9b, which illustrates the block 220 in side elevation, the block is formed from two right-angled prisms 221a, 221b. The first prism 221a is triangular in cross section and includes the active faces 220a, 220c, which are generally square and oriented perpendicularly to one another, a third surface (not labelled) representing the hypotenuse of the prism and two triangular side faces which form substantially half of the side faces 220b, 220d of the block 220.

The second prism 221b is similar in shape to the first prism 221a but this time includes the inactive faces 220e, 220f, an hypotenuse surface and two side surfaces which again form substantially half of the side faces 220b, 220d of the block 220.

In order to form the corner block 220, the two prisms 221a, 221b are joined or coupled together at their hypotenuse surfaces, for example by means of an adhesive or a mechanical joint. The reflective member 222 is disposed at the interface between the prisms 221a, 221b and, in one embodiment, is formed by coating the hypotenuse face of the first prism 221a with a metallic or otherwise reflective material.

Light transmitted into the block 220 through the active face 220a is reflected by the reflective member 222 and turned through 90° in order to exit the block through the other active face 220c. In this manner, the corner block can be used to deflect an optical signal through a right angle, thereby defining an optical path in at least two dimensions.

In an alternative arrangement (not shown), the second prism 221b is formed from a metal, chromic or other reflective material, rather than from the translucent material from which the first prism 221a is formed. This may facilitate manufacture of the corner blocks since the number of component parts is reduced, the second prism 221b itself forming the reflective member 222.

It is envisaged, for example, that such a corner block may be formed by extruding a length of transparent material which is triangular in cross section and adhering or otherwise fixing it to a similarly shaped length of the reflective material to form a single, square-section bar. The conjoined extrusions can then be cut or diced to the desired length in order to form the corner blocks.

The two types of blocks 210, 220 illustrated in FIGS. 8 and 9 can be coupled together, for example in the form of a matrix 204 described with reference to FIG. 7, to create a modular apparatus for guiding or directing an optical signal. A sequence of adjacent blocks can be arranged define a one-, two- or three-dimensional optical pathway wherein an optical signal input to the apparatus through the active face of a first one of the blocks can be transmitted or conducted through the structure and exit through the active face of a different block, for example in a different direction and/or in different plane.

In many cases, it is advantageous to use such a modular structure to conduct more than one optical signal. It will be understood that a plurality of such blocks arranged in a two- or three-dimensional matrix structure can be used to define several optical pathways in one, two or three dimensions.

However, in such an embodiment, it may be desirable to reduce or eliminate interference or cross-talk between the individual optical circuits or pathways.

In one embodiment, this is achieved by covering the “inactive” faces of each block with an opaque or reflective coating to prevent light being transmitted therethrough. For example, referring back to FIG. 8b, which illustrates the thru block 210 in front elevation, the inactive faces 210b, c, d, f are covered by a reflective or substantially opaque coating which hinders or prevents light being transmitted through these faces. The inactive faces of the corner block 220 can be coated in a similar manner.

In another embodiment (not shown), the inactive faces of the blocks are clad in a material having a lower refractive index to the material forming the body proper of the block. Here, signal propagation through the block may be achieved by the principle of total internal reflection in a manner similar to a conventional optical fibre.

In a still further embodiment, a third type of block (not shown) is employed. This third type of block is referred to as a “dead” block and comprises a cube, of similar dimensions to the thru and corner blocks 210, 220, formed from an optically non-conductive material such as opaque plastic. By suitable positioning of such dead blocks within the matrix structure 204, individual pathways formed by sequences of thru blocks 210 and corner blocks 220 can be optically isolated.

The functional effect of such a multiple-pathway, modular structure is similar to that of using a bundle of optical fibres, in that several optical signals can be conducted each entering and exiting the bundle at a different position and at a different angle. However, the modular structure described permits far simpler manufacture and assembly resulting in significantly lower production costs. Moreover, a greater number of paths with more complex three-dimensional orientations may be achieved within a given volume than with conventional optical fibres.

Referring now to FIGS. 10a-10c, these illustrate an optical arrangement 230 suitable for use in the key 100. FIG. 10a is a cross section through the key 230 in the Y-Z plane, FIG. 10b is a cross section through the key 230 in the X-Y plane and FIG. 10c is a cross section through the key 230 in the X-Z plane.

The arrangement 230 consists of a three-dimensional matrix 232 of blocks which are arranged to conform to the shape of the shank 120 of the key 100. In other words, the cross section of the matrix 232 is in the shape of a cross. The matrix 232 defines a plurality of individual optical pathways extending therethrough such that the ends of each optical pathway correspond to one of the apertures 130 or windows in the shank housing 120. Thus, a light beam or other optical signal transmitted into a pathway through one of the apertures in the shank housing 120 is conducted through the pathway and exits the housing through another window.

In FIGS. 10a-10c an exemplary optical signal, denoted by the solid arrowed line, is shown being transmitted along an optical pathway defined by the blocks within the matrix 232. In the illustrated example, the optical signal is shown entering the key through an active face of a thru block T1 and exiting the key through an active face of another thru block T6.

The pathway through which the optical signal is conducted is represented by the following sequence of blocks: Thru block T1, corner block C1 which turns the signal through 90° in the plane X-Z, thru block T2, thru block T3, corner block C2 which turns the signal through 90° in the X-Y plane, thru block T4, corner block C3 which turns the signal through 90° in the Y-Z plane, thru block T5 and thru block T6.

It will be appreciated that the arrangement 230 is capable of defining an almost unlimited number of other pathways by suitably arranging the thru and corner blocks. The number of possible pathways depends only on the number of blocks used in the matrix 232 and the shape thereof.

It is envisaged that the matrix 232 may be assembled prior to insertion into the shank housing 120 or, alternatively, that the blocks may be inserted or dropped individually, in clusters or in layers into the shank housing 120 thereby to form the matrix once all blocks have been inserted.

It will be appreciated that the invention is not limited by the embodiments disclosed hereinabove and that various modification could be made thereto within the scope of the claims appended hereto.

For example, the size and number of blocks used in the matrix structure can be selected as desired. Furthermore, the shape of the structure will depend to a large extent on the application to which it is to be put. In the embodiment of FIG. 7, the matrix structure 204 is a simple cube. In the embodiment of FIG. 10, the matrix 232 defines a cross shape corresponding to the interior of the key shank housing 120. However, any desired shape may be employed.

It is envisaged that each block may have sides of between 0.5 and 10 mm in length, with preferred sizes for cubic blocks being approximately 1-2 mm. However, the term “block” as used herein is not intended to be limiting in any way and it is envisaged that each block may be of any desired shape which permits a regular arrangement thereof to be constructed or which allows two such blocks to cooperate to form an optical path in at least two dimensions. For example, each block may be in the form of a sphere, spheroid, prism, cone, pyramid or any other three-dimensional shape which permits a regular arrangement or matrix to be assembled.

The blocks may be formed from any suitably transparent or translucent material. In particular, the material may be selected for their transparency at the wavelengths of the optical signals.

For example, where signals at visible wavelengths are used, the material used may be selected from, amongst others, polyurea, urea formaldehyde, polymethylacrylate, polystyrene or CD grade polycarbonate. Such materials are easy to manipulate and are suitable for injection moulding, permitting low cost fabrication to very high tolerances. Alternatively, conventional or optical grade glass, such as BK7, may be used. The refractive index of the material may be selected as desired but in one embodiment is between 1.54-1.58.

The propagation of optical signals along the optical pathways may be controlled and/or manipulated through the use of so-called channel-drop filters which are arranged to permit transmission only of optical signals having a specified range of wavelengths. For example, blocks may be provided which permit transmission only of signals at infrared wavelengths. Such channel drop filters may be formed by providing relevant blocks with a coating which is transparent only to light at the desired wavelengths.

It is envisaged that, in some circumstances, each individual block may be adapted to conduct two or more individual signals. For example, referring back to FIGS. 9a-9b, the reflective element 222 may be reflective on both faces thereof such that a first optical signal entering the block through the face 220a will be reflected through 90° to exit the block through face 220c (and vice versa) whilst a second optical signal entering the block through the face 120e will be reflected through 90° to exit the block through face 220f (and vice versa). The two signals will be optically isolated from each other by virtue of the reflectivity/opacity of the reflective element 222.

In this case, it will be understood that the corner block 220 can be said to have four active faces, 210a, c, e, f. Furthermore, the reflective member can be oriented at angles other than 45° to the active faces in order to achieve different angles of deviation of the optical signal.

In one embodiment, each block contains or encapsulates an optical fibre or other optical conductor or guide in order to conduct optical signals therethrough. In one embodiment, for example, the optical conductor comprises a through-bore or air core which may be used for transmission of the optical signal through the block. The encapsulated conductor could be a relatively linear or straight conductor for the purposes of a thru block or could be curved for the purposes of a corner block.

In this case, since the body proper of the block is not needed as a conductor, it may not be necessary to form the block from transparent or translucent material. Mirrors or other optical devices may also be embedded within the blocks which, being highly accurate and uniform elements, serve to create a modular structure permitting a substantially infinite number of variations thereof.

It may be desirable in some cases to ensure that the active surfaces of the blocks are polished and/or substantially free of blemishes since any opacity or frosting generated by a rough surface may detrimentally affect signal strength. Alternatively, any gaps formed between the blocks could be filled with index matching fluid where desired or UV curable adhesive resin.

The use of such an “exoskeleton” defined by a housing or by the pins 206 is entirely optional and it is envisaged that other means, such as an adhesive, may be provided to hold the blocks together. Alternatively, each block may be provided with means permitting it to interlock with one or more other blocks, in various orientations, so that a structure of substantially any desired shape can be constructed. In one embodiment (not shown), at least one face of a first block may be provided with a male interlocking part, such as a protruding pin or plug, which is adapted to engage with a corresponding female interlocking part, such as a hole or socket, formed in a face of a second block so as to secure the blocks together. Where the blocks used are multifaceted, each block may include a male interlocking part on one face thereof and a female interlocking part on another, possibly opposing, face thereof.

Using such an arrangement, the blocks may be interlocked to form a substantially self-supporting, three-dimensional structure of any desired shape, significantly increasing the range of applications for the apparatus.

Nevertheless, it may be desirable not to adhere or interlock the blocks so that they are held together only by the key shank housing 120. In this arrangement, any attempt to open the key shank housing (which may advantageously be substantially opaque so that the arrangement of blocks contained therein cannot be readily seen) for the purposes of discovering the arrangement of blocks forming the matrix will result in the blocks simply spilling out loosely, thereby frustrating such endeavours.

It will be appreciated that the above described aspect of the present invention provides an apparatus for conducting and/or guiding one or more optical signals which is simple to manufacture, easy to assemble and which provides a large number of optical pathways with almost infinite variation.

Although the present application describes the invention in the context of a locking system, no limitation is intended by this and it is envisaged that the optical arrangement may be employed in substantially any application in which one or more optical signals are required to be conducted between two or more locations. It is particularly envisaged that matrices of blocks of the type described above may eventually replace optical fibres in optical or optoelectronic systems of any kind.

1. An apparatus for conducting an optical signal comprising a plurality of optically conductive blocks, each block cooperating with another to define a pathway for the optical signal in at least two dimensions.

2. An apparatus as claimed in claim 1 wherein each block is regular in shape, having at least one face or surface which cooperates with that of another block.

3. An apparatus as claimed in claim 1 wherein at least one of the blocks comprises a cube having six faces.

4. An apparatus as claimed in claim 1 wherein each of the blocks is substantially identical in size and/or shape.

5. An apparatus as claimed in claim 1 comprising means for fixing or securing or holding the blocks together in a two- or three dimensional matrix.

6. An apparatus as claimed in claim 5 wherein the matrix defines a plurality of optical pathways for conducting a plurality of optical signals.

7. An apparatus as claimed in claim 1 wherein at least one of the blocks has two opposing, optically conductive faces thereby to define a substantially straight pathway for an optical signal therebetween.

8. An apparatus as claimed in claim 7 wherein the remaining face or faces of the block may include means for reducing or substantially preventing transmission of the optical signal therethrough.

9. An apparatus as claimed in claim 1 wherein at least one of the blocks includes beam directing means for changing the direction of transmission of an optical signal through the block.

10. An apparatus as claimed in claim 9 wherein the beam directing means comprises a reflective member such as a mirror disposed within the block and inclined relative to one of the faces thereof.

11. An apparatus as claimed in claim 10 wherein the reflective member is disposed within the block at an angle of approximately 45° relative to two mutually perpendicular faces thereof.

12. An apparatus as claimed in claim 10 wherein the reflective member is reflective on two opposing sides thereof for the conduction of two optically isolated signals therethrough, each optical signal being turned through approximately 90°.

13. An apparatus as claimed in claim 1 wherein at least one of the blocks is substantially optically non-conductive, for terminating an optical pathway within the apparatus and/or for optically isolating individual optical signals within the apparatus.

14. An apparatus as claimed in claim 1 wherein each block is formed from one or more of the following materials: polyurea, urea formaldehyde, polymethylacrylate, polystyrene or CD grade polycarbonate.

15. A locking mechanism for a door, window or the like comprising a lock barrel and a key adapted for insertion into the barrel, at least one of the lock barrel and the key including an apparatus as claimed in any preceding claim.

16. A locking mechanism suitable for a door or window, the mechanism comprising a barrel having a passage or keyway disposed therein, a key arranged for insertion into the passage or keyway, one or more light sources for generating and transmitting an optical signal and one or more receivers for receiving the or each optical signal, wherein the key includes a plurality of optically conductive units arranged substantially regularly therein for optically coupling the light sources and the receivers thereby to operate the locking mechanism.

17. A locking mechanism as claimed in claim 16 wherein the optically conductive units comprises an arrangement as claimed in claim 1 disposed within the key.

18. A locking mechanism as claimed in claim 16 wherein the optically conductive units comprise one or more photonic crystals or similar disposed within the key.

19. A locking mechanism as claimed in claim 16 further comprising encoder means for encoding the optical signal before it is transmitted.

20. A locking mechanism as claimed in claim 19 further comprising decoder means for decoding the signal after it is received.
